(19) United States
(12) Patent Application Publication
(10) Pub. No.: US 2010/0182399 A1
(43) Pub. Date: Jul. 22, 2010

(54) PORTABLE TERMINAL

(75) Inventors: Sung-Wook CHOI, Suwon-si (KR); Young-Kwon Yoon, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/692,262

(22) Filed: Jan. 22, 2010

(30) Foreign Application Priority Data
Jan. 22, 2009 (KR) 10-2009-0005544

(51) Int. Cl. H04N 7/00

(52) U.S. Cl. 348/36; 348/231.99; 348/E07.001

(57) ABSTRACT

A method for determining user input in a portable terminal, and a portable terminal for determining user input are provided. The portable terminal includes an input means for providing at least one key to a user; a camera module including a wide-angle lens system, capable of monitoring the input means, and an image sensor for converting a light incident from the lens system into image data; and a controller for calculating a user-selected key or menu based on the image data, wherein the controller determines whether the image data corresponds to the user-selected key or menu according to a view angle of a light incident from the lens system.

### PRIORITY

This application claims priority under 35 U.S.C. §119(a) to a Korean Patent Application filed in the Korean Intellectual Property Office on Jan. 22, 2009 and assigned Serial No. 10-2009-0005544, the entire contents of which are incorporated herein by reference.

### BACKGROUND OF THE INVENTION

1. Field of the Invention

The present invention relates generally to a portable terminal, and more particularly, to an input means of a portable terminal with a camera module.

2. Description of the Related Art

Recently, with the increased usage of many communication technologies, various types of portable terminals having a plurality of functions integrated therein have come into wide use. For example, such portable terminals may include cell phones, Portable Multimedia Players (PMP), PlayStation® Portable (PSP) devices, navigators, Digital Multimedia Broadcasting (DMB) receivers, notebook computers, Motion Picture Experts' Group (MPEG) Audio-Layer 3 (MP3) players, etc.

As the number of functions provided in portable terminals have increased, portable terminals require an input means capable of selecting the functions.

However, due to a need for their portability, the portable terminals have size limitations, and therefore there is a need for an intuitive input means that ensures easy input.

### SUMMARY OF THE INVENTION

An aspect of the present invention is to address at least the above-mentioned problems and/or disadvantages and to provide at least the advantages described below. Accordingly, an aspect of the present invention is to provide a portable terminal with a touch screen with which it is easy to input information.

According to one aspect of the present invention, there is provided a portable terminal including an input means for providing at least one key to a user; a camera module including a wide-angle lens system, capable of monitoring the input means, and an image sensor for converting a light incident from the lens system into image data; and a controller for calculating a user-selected key or menu based on the image data, wherein the controller determines whether the image data corresponds to the user-selected key or menu according to a view angle of a light incident from the lens system.

According to another aspect of the present invention, a method for determining user input in a portable terminal is provided. The method includes providing, by an input means, at least one key to a user; monitoring, by a camera module including a wide-angle lens system, the input means; converting, by an image sensor, a light incident from the lens system into image data; and calculating, by a controller, a user-selected key, based on the image data, wherein the controller determines whether the image data corresponds to the user-selected key or menu according to a view angle of a light incident from the lens system.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a schematic block diagram of a portable terminal according to an embodiment of the present invention;

FIG. 2 is a cross-sectional view of a portable terminal according to an embodiment of the present invention;

FIG. 3 is a cross-sectional view of the lens system shown in FIG. 1;

FIG. 4 is a graph showing off-axis image points based on a focal distance of the lens system shown in FIG. 3; and

FIGS. 5A and 5B are diagrams showing a method for inputting a menu using the portable terminal shown in FIG. 1.

Throughout the drawings, the same drawing reference numerals will be understood to refer to the same elements, features and structures.

### DETAILED DESCRIPTION OF EMBODIMENTS OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

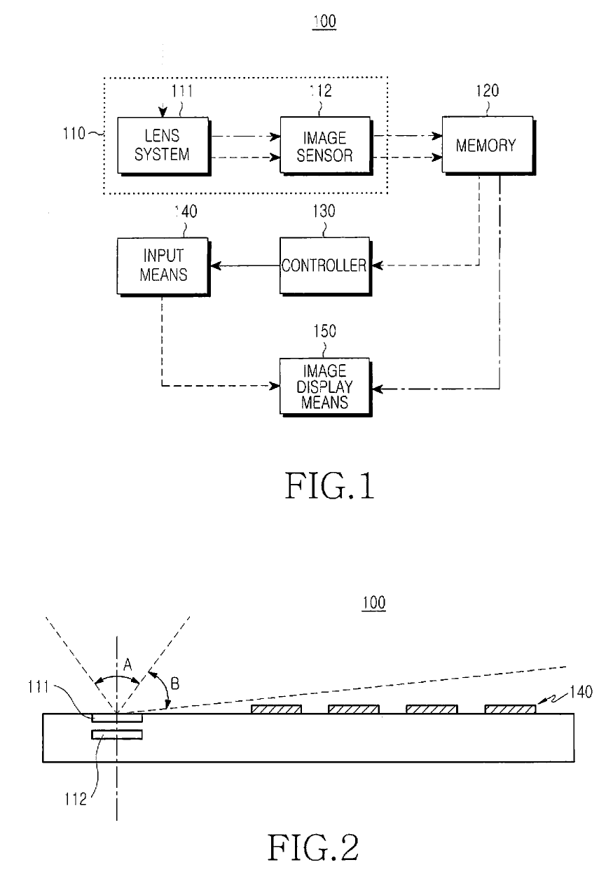

FIG. 1 schematically illustrates a portable terminal with a camera module according to an embodiment of the present invention. Referring to FIG. 1, a portable terminal 100 includes an input means 140 for providing at least one key and/or menu, a wide-angle camera module 110, capable of monitoring the input means 140 on the whole, a memory 120 for storing light data (or image data) received from the wide-angle camera module 110, a controller 130 for determining a key or menu selected by a user based on wide-angle image data (obtained at a wide view angle) among the image data provided from the memory 120, and an image display means 150 for providing image data provided from the controller 130 and the memory 120, to the user.

The input means 140 may provide an ordinary keypad or a plurality of keys (or menus) to the user. However, when the input means 140 includes a touch screen, the keys or menus may be provided in the form of images on the image display means 150. More specifically, when a touch screen is used as the image display means 150, the input means 140 may be provided to the user through the image display means 150. In this case, the input means 140, which is provided through the image display means 150, may be controlled by the controller 130.

The camera module 110 may include a wide-angle lens system 111 and an image sensor 112. While an image photographed in a zone where a view angle of the lens system 111 is narrow may be used as image data, an image photographed in a wide-angle zone may be used for calculating input information selected by the user. FIG. 2 shows a cross section of a portable terminal according to an embodiment of the present invention, in which a view angle of the lens system 111 may be divided into view angle A and view angle B. A light incident at the view angle A may be provided to the user as general image data (moving or still images), whereas a light incident at the view angle B may be stored in the memory 120 through the image sensor 112 as image data for calculating a key or menu selected by the user.

A detailed example of image data based on the view angle of the lens system 111 will be given below. An image photographed at the view angle A of 60° or less may be used as image data for the general moving or still image, while image data photographed at the view angle B between 60° and 150° may be used for calculating a key selected by the user or selection information.

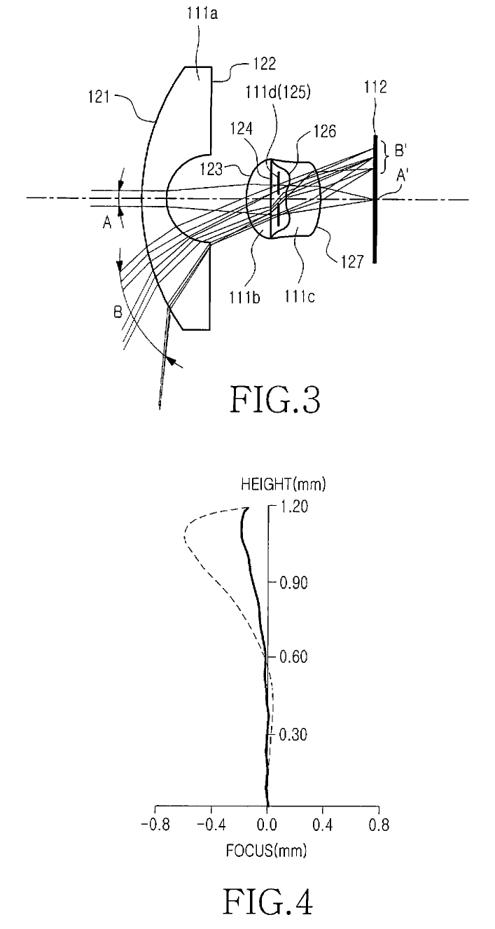

In the case of the lens system 111, a difference in focal distance due to the different view angles in use may be minimized by making the camera lens system 111 such that it includes a curved surface on which an image is formed. FIG. 3 shows a design of a lens system applicable to a camera module according to an embodiment of the present invention. Referring to FIG. 3, the zones A′ and B′ where an image is formed on the image sensor 112 are different according to the view angles A and B.

TABLE 1

| Surface | Surface | Y-axis curvature | Thickness | |
|---|---|---|---|---|
| number | type | (mm) | (mm) | Glass |
| 1 | Conic | 5.4 | 0.42 | SBSM81_OGARA |
| 2 | Spherical | 0.92 | 1.6 | |
| 3 | Aspherical | 1.17 | 0.5 | STIH6_OHARA |
| 4 | Aspherical | 3.05 | 0.24 | |
| 5 | Iris | Infinity | 0.1 | |
| 6 | Aspherical | 4.1 | 0.66 | SLAL18_OHARA |
| 7 | Aspherical | −1.53 | 1.13 | |
| 8 | Top | | 0 | |

FIG. 4 is a graph showing off-axis image points based on a focal distance of the lens system shown in FIG. 3. As shown in FIG. 4, the lens system 111 is designed such that atop surface, on which an image is formed, is curved, which enables simultaneous photographing of image data of moving and still images and image data for calculating information (key or menu) selected by the user.

First lens 111a includes first and second surfaces 121 and 122, wherein the first surface faces towards a subject to be photographed. A second lens 111b includes third and fourth surfaces 123 and 124. An iris 111d includes a fifth surface 125. A third lens 111c includes sixth and seventh surfaces 126 and 127, wherein the seventh surface 127 faces the image sensor 112.

The image sensor 112 can be used in converting a light received through the camera module 110 into image data, and the converted image data may be subsequently provided to the user. The image sensor 112 may also calculates a key selected by the user or input information selected by the user from an image, light, or light information photographed at a wide view angle. A Complementary Metal-Oxide Semiconductor (CMOS) or Charge-Coupled Device (CCD) for a video call may be included in the image sensor 112. Alternatively, a high-resolution CMOS or CCD may also be included in the image sensor 112.

Image data obtained from the image sensor 112 is provided to the memory 120, which provides the image data to the controller 130 and the image display means 150. The image data can be divided into image data (indicated by dot-dash lines) of moving images and still images, and image data (indicated by dotted lines) for inputting information (key or menu) by the user, according to the view angles A and B where the image is photographed. The image data of moving and still images may be provided to the user through the image display means 150, whereas the image data for inputting information (key or menu) by the user is provided to the controller 130, which calculates a key or menu selected by the user based on the image data.

If a touch screen is used as the image display means 150, the input means 140 may be provided to the user through the image display means 150. In this case, the controller 130 may convert the input means 140 into a sub-key or sub-menu of the key or menu selected by the user, and the converted sub-key or sub-menu of the input means 140 may be provided or displayed to the user through the image display means 150.

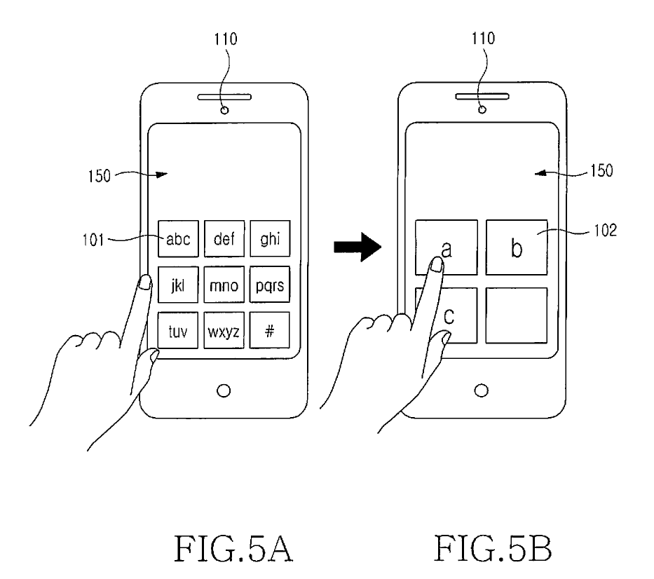

FIGS. 5A and 5B illustrate an example in which an input means is converted into a sub-menu of the key or menu selected by the user when a touch screen is used as the image display means 150. An exemplary portable terminal shown in FIGS. 5A and 5B may include the camera module 110 capable of wide-angle photographing, the image display means 150 realized with a touch screen, and the input means 140 for providing keys or menus to the user through the image display means 150.

FIG. 5A shows an example where a user selects a key 101, and FIG. 5B shows an example of an input means that is converted into a sub-key (or sub-menu) 102 of the key 101 selected by the user, and then provided to the user.

The portable terminal 100 according to the present invention may calculate a position of a key the user desires to select, by calculating an angle of a user's body (or a portion of the user's body) photographed by the camera module 110. Since pixels on which a light reflected from a subject is incident (i.e., pixels of an image photographed by a camera module that include a part of the user's body) may correspond to positions of the keys, the controller 130 may calculate a key selected by the user based on preset data. Since the image sensor 112 is divided into a plurality of pixels, a pixel position of the image sensor 112 corresponding to a position at which the user's body is detected, can be determined. Therefore, a key selected by the user can be calculated based on the pixel position.

As is apparent from the foregoing description, the portable terminal according to the present invention detects a user's motion using the wide-angle camera module and calculates a key selected by the user based on the detected user's motion, thereby minimizing an information input time compared to the conventional portable terminal in which the user inputs information by actually pressing keys.

According to embodiments of the present invention, a portable terminal with a touch screen calculates a selected menu (according to a key or a position) based on a position of a user's pointing instrument (such as a finger, for example), thereby calculating a menu touch-selected by the user and providing its sub-menu.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A portable terminal comprising:
an input means for providing at least one key to a user;
a camera module including a wide-angle lens system, capable of monitoring the input means, and an image sensor for converting a light incident from the lens system into image data; and
a controller for calculating a user-selected key or menu based on the image data, wherein the controller determines whether the image data corresponds to the user-selected key or menu according to a view angle of a light incident from the lens system.

2. The portable terminal of claim 1, wherein the lens system has a curved surface on which an image is formed.

3. The portable terminal of claim 2, wherein the controller provides an image of a subject photographed at a view angle of 60° or less of the lens system to the user as image data, and uses an image of a subject photographed at a view angle between 60° and 150°, for calculating the user-selected key or menu.

4. The portable terminal of claim 3, wherein the input means includes a touch screen.

5. The portable terminal of claim 1, further comprising:
a memory for storing the image data converted by the image sensor, and providing the stored image data to the controller; and
an image display means for displaying a confirmation of the calculated user-selected key or menu.

6. The portable terminal of claim 4, wherein the controller converts the input means into a sub-key or sub-menu of the calculated key or menu, and provides the sub-key or sub-menu to the user.

7. A method for determining user input in a portable terminal, the method comprising:
providing, by an input means, at least one key to a user;
monitoring, by a camera module including a wide-angle lens system, the input means;
converting, by an image sensor, a light incident from the lens system into image data; and
calculating, by a controller, a user-selected key, based on the image data, wherein the controller determines whether the image data corresponds to the user-selected key or menu according to a view angle of a light incident from the lens system.

8. The method of claim 7, wherein the lens system has a curved surface on which an image is formed.

9. The method of claim 8, further comprising:
providing, by the controller, an image of a subject photographed at a view angle of 60° or less of the lens system to the user as image data; and
using, by the controller, an image of a subject photographed at a view angle between 60° and 150° for calculating the user-selected key or menu.

10. The method of claim 9, wherein the input means includes a touch screen.

11. The method of claim 7, further comprising:
storing, by a memory, the image data converted by the image sensor;
providing, by the memory, the stored image data to the controller; and
displaying, by an image display means, a confirmation of the calculated key or menu selected by the user.

12. The method of claim 10, wherein the controller converts the input means into a sub-key or sub-menu of the calculated key or menu, and provides the sub-key or sub-menu to the user.
